(19) United States
(12) Patent Application Publication
(10) Pub. No.: US 2022/0348772 A1
(43) Pub. Date: Nov. 3, 2022

(54) Substrates having superhydrophobic surfaces, methods of producing the same and the use thereof

(71) Applicant: Aalto-korkeakoulusäätiö sr., Aalto (FI)

(72) Inventors: Robin Ras, Aalto (FI); Dehui Wang, Aalto (FI); Xu Deng, Aalto (FI)

(21) Appl. No.: 17/765,518

(22) PCT Filed: Jun. 2, 2020
(86) PCT No.: PCT/FI2020/050383

§ 371 Date: Mar. 31, 2022

(30) Foreign Application Priority Data
Oct. 1, 2019 (FI) 20195835

(51) Int. Cl. C09D 5/16; C09D 5/34

(52) U.S. Cl. CPC C09D 5/1681; C09D 5/1675; C09D 5/34; B82Y 30/00

(57) ABSTRACT

A substrate having a superhydrophobic surface and methods of manufacturing the same and uses thereof. The substrate comprises a frame of a first material of interconnected structures exhibiting cavities having the shape of inverted pyramids; and a second material comprising hydrophobic structures filling the cavities, wherein the sidewalls of the inverted pyramids form an angle α of 105°<α<135° against the surface. The hydrophobic structures, such as nanoparticles, provide excellent water repellency, whereas the structures formed by a mechanically durable substrate material, typically comprising microstructures, act as armor to resist abrasion. The substrates are robust, durable and abrasion resistant and can be used as surfaces in self-cleaning, anti-fouling or heat transfer materials as well as in transparent surfaces, in particular in solar cells.

### FIELD OF INVENTION

The present invention relates to superhydrophobic materials and their uses. In particular, the present invention concerns substrates having superhydrophobic surfaces comprising hydrophobic materials and a supporting frame.

Further, the present invention also concerns methods of manufacturing superhydrophobic materials, as well as uses of the novel materials.

### BACKGROUND

Superhydrophobic surfaces with multiple functions such as self-cleaning, anti-biofouling and staying dry are promising for applications in biotechnology, medicine and heat transfer. Water droplets placed on superhydrophobic surfaces feature large apparent contact angle (θ*>150°) and low roll-off angle (θ_{roll-off}<10°). To achieve superhydrophobicity, two conditions must be met: a low liquid-solid contact fraction (f) created by micro—or nanoscale surface roughness, and low-surface-energy chemistry.

However, a primary problem hindering the widespread adoption of superhydrophobic surfaces is that surface roughness is fragile and highly susceptible to abrasion, especially for nanoscale surface textures as they bear high pressures under mechanical load. Additionally, abrasion exposes underlying materials and may change the local surface chemistry from hydrophobic to hydrophilic leading to the pinning of water droplets and loss of superhydrophobicity.

Superhydrophobicity can be enhanced by minimizing liquid-solid contact area. However, low liquid-solid contact area yields high local pressures under mechanical load, resulting in fragile surface textures and poor wear resistance. As a result, for achieving mechanically robust superhydrophobicity, enhancing of one performance inescapably results in decreased performance in the other.

Various approaches have been devised to meet this challenge, allowing only modest improvements of robustness, e.g.: (i) strengthening the bonding between coating and substrate by using an adhesion layer, (ii) bearing the abrasion force by randomly introducing discrete microstructures and (iii) allowing abrasion by sacrificing the upper layers of a self-similar structure.

### SUMMARY OF THE INVENTION

The present invention aims at eliminating at least a part of the problems relating to the art and to provide novel superhydrophobic materials.

In an aspect, the present invention provides superhydrophobic materials comprising a layer of a first material which has a surface. The first material exhibits interconnected structures formed by inverted pyramids having sidewalls which define cavities in the material. The cavities of the material are filled with a second material, which is formed by or comprises hydrophobic structures. The sidewalls of the inverted pyramids form generally an angle α of 105°<α<135° against the hydrophobic surface.

In one aspect, the first material will form an armor giving the superhydrophobic material properties of mechanical strength, the second material will render the superhydrophobic material hydrophobic properties.

The superhydrophobic materials can be produced by providing a frame of a first material exhibiting cavities, in particular by forming into the first material cavities defined by the sidewalls of inverted pyramids. The sidewalls of the inverted pyramids form an angle α of 105°<α<135° against the surface of the said surface. The cavities are filled with hydrophobic structures, in particular nanostructures.

The novel materials have a number of uses, for example, in the fields of biotechnology, medicine, heat transfer and solar cell technologies.

More specifically, the present invention is mainly characterized by what is stated in the characterizing portion of the independent claims.

Considerable advantages are obtained by the invention. Thus, the materials according to the invention defy the common assumption that mechanical robustness and water repellency are mutually exclusive properties. By decoupling the design criteria for fracture mechanics and non-wetting, an armor concept is provided that enables unprecedented levels of performances.

Tests show that with the present structures, water repellency can be preserved after sharp steel blade and sandpaper abrasion, and even 1000 cycles of linear abrasion using polypropylene abradant and a pressure of 12 MPa.

The present technical solution can be achieved using various substrates including silicon, ceramics, metals, metal alloys, polymers and glasses, such as transparent glass.

Embodiments include transparent, mechanically robust self-cleaning windows that will greatly reduce the efficiency loss in solar cells caused by dust contamination.

Further, embodiments of the present invention can be used as self-cleaning, anti-fouling and heat transfer materials operating under harsh environments.

Next embodiments will be examined in more detail with reference to the attached drawings.

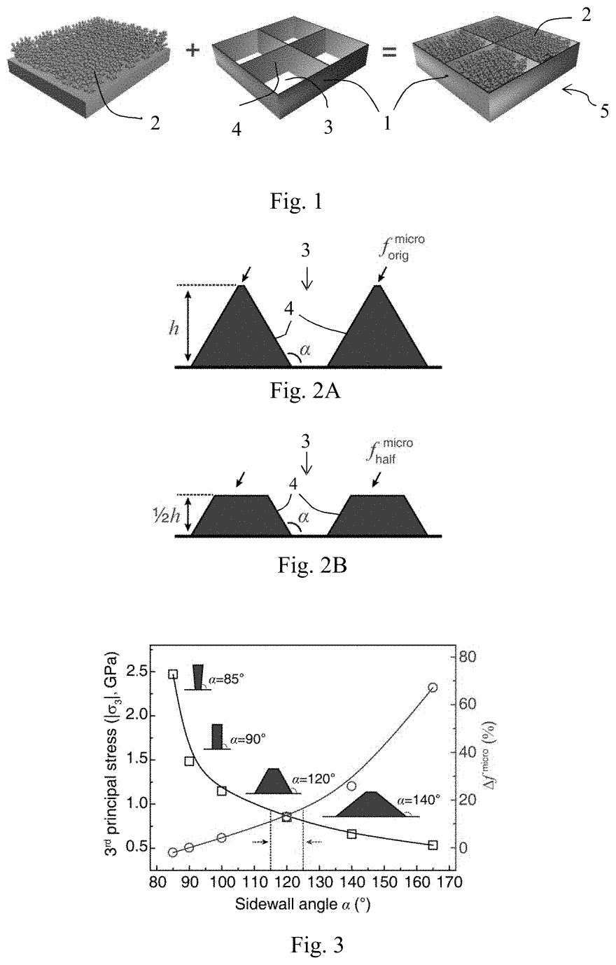

FIG. 1 shows in perspective the steps of forming a superhydrophobic material according to an embodiment of the invention;

FIGS. 2A and 2B are schematic cross-sections showing the change of contact area on top of the framework structures when height h is reduced to half of its original value by abrasion FIG. 3 shows the influence of mechanical stability and change of the liquid-solid contact fraction Δf^{micro} as function of the sidewall angle (a);

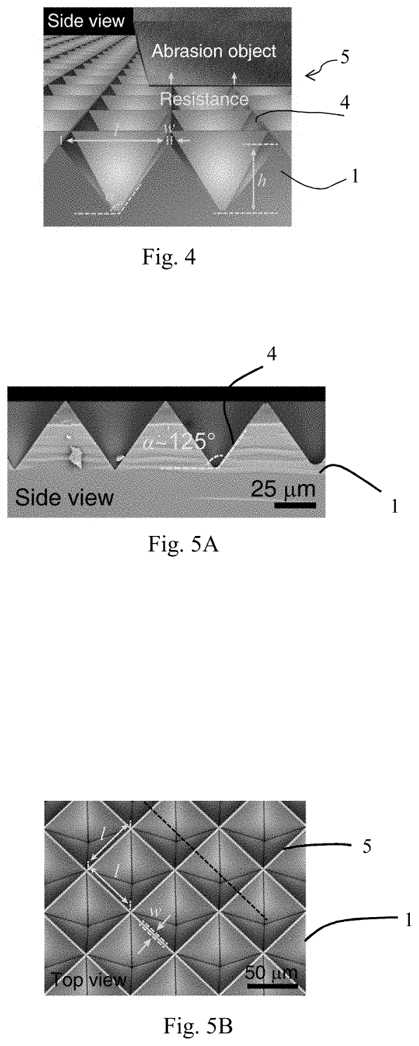

FIG. 4 shows in perspective view an array of microscale inverted pyramidal cavities as the designed armor. w is the distance between adjacent cavities, l is width of the cavities, and h is the height;

FIGS. 5A and 5B are scanning electron micrographs of the inverted pyramidal armor on silicon substrates;

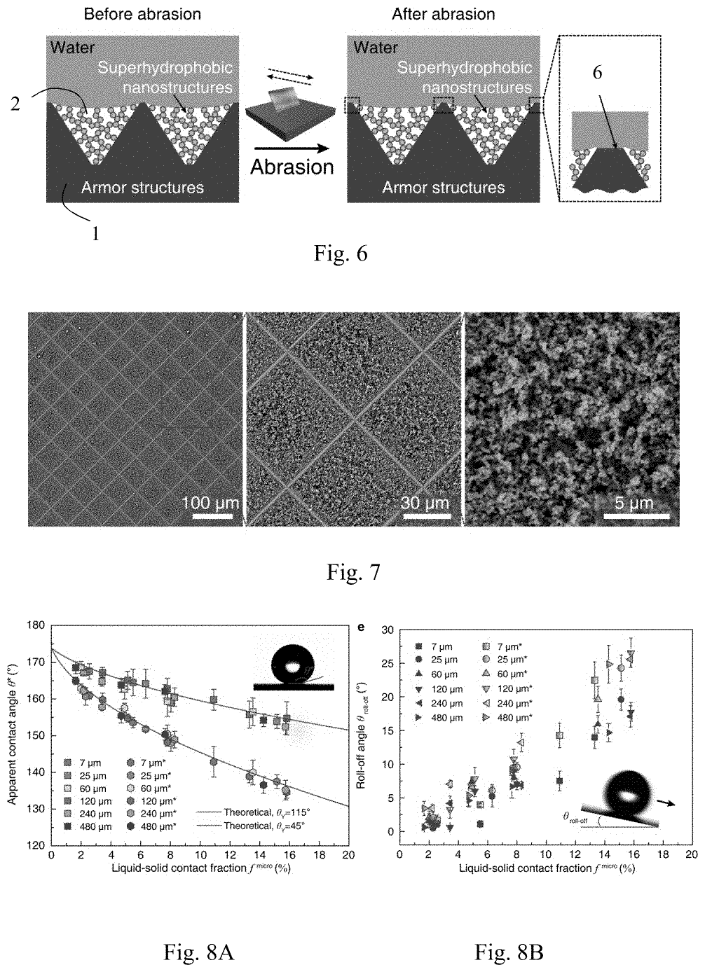

FIG. 6 shows the water repellency mechanism for the armored nanostructured superhydrophobic surface before and after abrasion;

FIG. 7 are scanning electron micrographs at different magnification of silica fractal nanostructures on silicon armor after abrasion;

FIGS. 8A and 8B shows the apparent contact angle and roll-off angle as function of liquid-solid contact fraction, before and after abrasion;

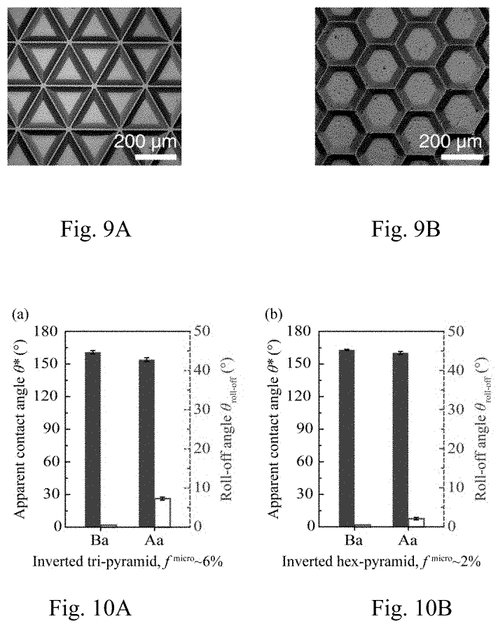

FIGS. 9A and 9B are scanning electron micrographs showing the inverted tri-pyramidal structures on silicon substrate (FIG. 9A) and inverted hex-pyramidal structures on anodised aluminium alloy substrate (FIG. 9B);

FIGS. 10A and 10B indicate the apparent contact angle (dark-coloured bars) and roll-off angle (light-coloured bars) of the silicon inverted tri-pyramidal (FIG. 10A) and anodised aluminium inverted hex-pyramidal (FIG. 10B) armored surfaces before abrasion (Ba) and after abrasion (Aa)—all error bars indicate standard deviations from at least five independent measurements;

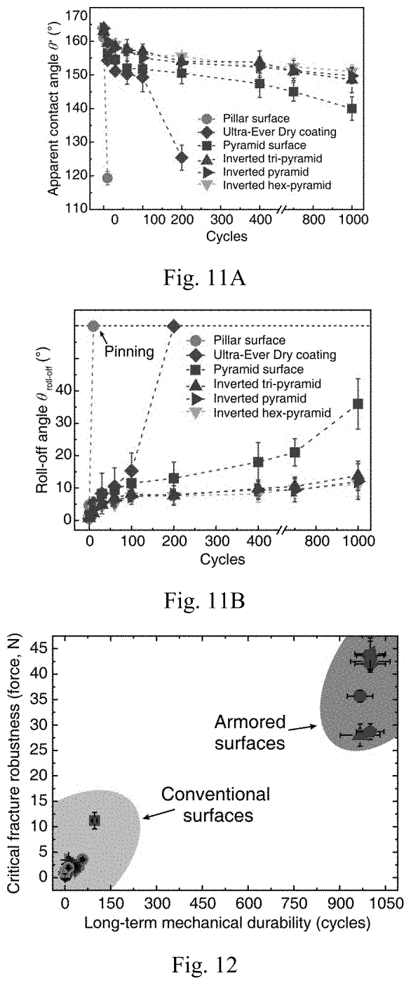

FIGS. 11A and 11B show the influence of linear abrasion cycles under the same load on apparent contact angle θ* (FIG. 11A) and roll-off angle θ_{roll-off} (FIG. 11B) for various superhydrophobic coatings; the key is the same for both panels, and data are mean±s. d. from at least five independent measurements; and

FIG. 12 is a comparison of the mechanical stability among different superhydrophobic surfaces; the same color area indicates the superhydrophobic surfaces with mechanical stability on the same order of magnitude, and the error bars indicate standard deviations from at least five independent measurements.

### EMBODIMENTS

In an embodiment, substrates are provided having a patterned superhydrophobic surface, wherein the patterns of the superhydrophobic surface comprise cavities formed into a first material, the cavities being shaped as inverted pyramids in that material. The walls of the cavities typically form an angle α of 105°<α<135° against the surface.

In the present context, “superhydrophobic surfaces” are surfaces that achieve high contact angle and low roll-off angle by trapping air within the topographical structures, making that the liquid droplet is in contact mostly with air and very little with the solid surface.

Typically, the surfaces have an apparent contact angle (θ*) greater than 150°, and roll-off angle (θ_{roll-off}) of less than 10°.

In one embodiment, the present substrates are considered to be superhydrophobic when the apparent contact angle θ* is ca 154° and θ_{roll-off} is ca 8°.

“Liquid-solid contact fraction” is the fraction of the solid surface area in contact with (or wetted by) the liquid. The fraction of the solid surface area not in contact with the liquid is in contact with the air layer that is trapped between liquid and solid.

“Pyramid” and “pyramidal” refers to a polyhedron and to the shape thereof, respectively. In the polyhedron one face, i.e. the “base”, is a polygon of any number of sides, and the other faces are triangles whose bases are the sides of the polygon and which meet at a common vertex. In the present context, the term “pyramid” also includes truncated pyramids, in which the sides are formed by tetragons, such as trapeziums, rather than by triangles. It should be noted that the term “truncated” is not to be understood in its strictest mathematical meaning but as an indication of the tapering end of the pyramid not ending in a sharp and pointed end but rather in a blunt end.

The term “inverted pyramid” refers to a pyramid standing on its smaller end.

In the present context, the term “inverted pyramid” is applied to the 3-dimensional shape of the cavities formed in the substrate. The cavities have openings, corresponding to the base of a pyramid, opening up on the surface of the substrate, i.e. on the superhydrophobic side, of the substrate.

As will be understood, the cavities are defined by an envelope surface having the shape of a pyramid extending, typically perpendicularly, from the surface towards the opposite surface of the surface. The cross-section of the cavities will typically have the shape of a triangle or trapezium with its smaller end pointing away from the surface of the substrate.

Thus, as further will be appreciated, the cavities have a “pyramidal” shape.

In the present context, the term “substrate” is understood to stand for a piece of material capable of being processed to provide a surface having properties of superhydrophobicity. Such a processed material is also being referred to as a “frame”.

Typically, the substrate comprises at least one planar surface. In embodiments the substrate comprises two planar surfaces, preferably two parallel planar surfaces. In other embodiments, the superhydrophobic surface has a non-planar shape, such as curved.

The surfaces of the present substrates exhibit a pattern formed by a plurality of cavities opening at the surfaces and tapering towards the other surface of the substrate. The opposite end of the cavities will have a shape, for example, akin to a sharp tip or a truncated tip. However, it should be noted that the opposite end does not need to have a strictly defined geometric shape. The tip of the cavities can be closed or open.

In one embodiment, the frame of the present superhydrophobic substrates is formed by a plurality of adjacent, truncated, inverted pyramidal structures which are interconnected at their sidewalls at or close to the base of the inverted pyramidal structures.

The bases of the pyramids which define the cavities comprise polygons with typically 3 to 13 edges.

The cavities are preferably filled with hydrophobic structures of a second material. Such structures may include particulate or fibrous matter. The structures may also comprise patterns of roughness, such as random roughness, on the cavity-facing sides of the walls. Roughness of the walls can be obtained for example by etching, in particular chemical etching.

In one embodiment, the cavities are completely or essentially completely filled with the hydrophobic material. In one embodiment, the hydrophobic material fills the cavities up to essentially the level corresponding to the bases of the inverted pyramidal cavities.

In one embodiment, the walls of the cavities are coated with the hydrophobic material. In one embodiment, the walls are coated and the walls are provided with a pattern of roughness to increase the surface area of the walls. In one embodiment, the hydrophobic material will form a coating of the walls, the coating typically having a thickness of about 10 to 250 nm.

Typically, the hydrophobic structures have a greatest dimension of 1000 nm or less, in particular 5 to 250 nm or 10 to 150 nm, whereas the openings of the cavities have a greatest dimension of from about 5 μm up to 250 μm or more, e.g. up to 500 μm or more, such as up to 750 or even up to 1000 μm), i.e. typically in the micrometer range. The “greatest dimension” is measured perpendicularly to the central axis of the cavity, or—typically— in a plane parallel to the surface of the substrate.

With a structure of the instant kind, the mechanical durability and non-wettability functionalities of the superhydrophobic surfaces are separated and implemented preferably at two different length scales: the hydrophobic structures, such as nanostructures, provide excellent water repellency, whereas the structures formed by a mechanically durable substrate material, typically comprising microstructures, act as armor to resist abrasion.

In one embodiment, the substrate exhibits properties selected from the group of robustness, durability and abrasion resistance and combinations thereof.

In one embodiment, the superhydrophobic substrate is capable of exhibiting superhydrophobicity even after at least 100 cycles, preferably even after 120 to 240 cycles, of a Taber abrasion test performed following the ASTM D4060 standard, using a Taber abrasion tester on a substrate with a size of 10.5 cm * 10.5 cm.

In one embodiment, the superhydrophobic substrate is capable of exhibiting superhydrophobicity even after several hundreds of cycles of linear abrasion carried out with an abradant at a predetermined pressure. Thus, in one embodiment, the substrate is capable of exhibiting superhydrophobicity even after 500 cycles, for example even after 1000 cycles, of linear abrasion with polypropylene (PP) abradant at an applied pressure of 12 MPa.

In one embodiment, the superhydrophobic substrate is capable of exhibiting superhydrophobicity even after 100 cycles of a tape-peeling test carried out using a tape having an adhesion to steel of 3000 N m⁻¹ and applied against the surface using a 4.5 kg weight, such as a cylindrical weight, for example as a roller.

In the above embodiments, the present substrates are considered to be superhydrophobic when the apparent contact angle (θ*) greater than 150°, and roll-off angle (θ_{roll-off}) of less than 10°, in particular when the apparent contact angle θ* is ca 154° and θ_{roll-off} is ca 8°.

Turning now to the drawings, in FIG. 1, which depicts an embodiment in perspective view, reference numeral 1 stands for the armoring material, typically a hard, mechanically durable material, which forms a frame of interconnected structures of inverted pyramid shape forming cavities 3 defined by slanted side-walls 4. Reference numeral 2 stands for nano-sized structures, such as particulate material, having particle sizes in the range of less than 1000 nm, typically 10 to 500 nm, and which has hydrophobic properties. By combining the two materials, more specifically by filling the cavities 3 with the particulate material 2, a superhydrophobic material 5 is achieved.

The present materials can be manufactured by a process comprising in one embodiment the steps of providing a frame of a first material of interconnected structures, exhibiting cavities having the shape of inverted pyramids, wherein the walls of the cavities forming an angle α of 105°<α<135° against the surface; and providing a second material comprising hydrophobic structures to at least partially fill the cavities.

In one embodiment, the cavities are provided by forming in the surface a frame of interconnected structures, with cavities having the shape of inverted pyramids, for example by a method selected from the group of embossing, roll-to-plate imprinting, or roll-to-roll imprinting of the substrate. Other methods are, for example, laser patterning, laser ablation, and additive manufacturing (also called 3D printing).

One embodiment comprises using a mould having protrusions in the form of pyramids for forming pattern of inverted pyramids in a surface of the substrate. In this embodiment, the pyramidal structure of the mould will correspond to the inverted pyramidal shape of the cavities. Thus, it is possible, for example, to use moulds having pyramidal protrusions having a sharp tip or a truncated tip.

In one embodiment, the hydrophobic structures are bonded to the cavity-facing surfaces of the sidewalls of the inverted pyramids by physical or chemical bonds or by both physical and chemical bonds. Examples of bonds include electrostatic bonds, hydrogen bonds, ionic bonds and covalent bonds.

In one embodiment, the substrate is subjected to a treatment in order to increase bonding of the hydrophobic structures to the cavities. Such a treatment can, for example, be carried out by plasma etching, by chemical etching or by using a primer or a combination thereof. As will be apparent, the armor 1 formed by the interconnected frame prevents abradants greater than the frame size from removing the nanostructures 2 in the cavities 3.

FIG. 2 shows in cross-section of one cavity, according to an embodiment, how the contact area on the top of the framework structures changes when abrasion fractures the height h in half.

As further will appear, the interconnectivity of the structure enhances mechanical robustness, in one embodiment, as inspired by nature, e.g. springtail skin and honeycomb. Further, wettability is ensured. In this respect, reference is made to the relation between the liquid-solid contact fraction f the Young's contact angle θ_{Y} and the apparent contact angle θ* using the Cassie-Baxter model:

cos θ*=f(1+COS θ_{Y})−1 (I)

In the Cassie-Baxter wetting state, the role of Young's contact angle is investigated by plotting equation (I) with θ_{Y}. The difference (Δθ*) between the θ* values of the hydrophobic (θ_{Y}=120°) surface and hydrophilic (θ_{Y}=0°) surface gets smaller as f decreases. In other words, even if during abrasion the top surface would be altered from hydrophobic to hydrophilic, the armored surface can still repel water if f is very small.

FIG. 3 shows the mechanical strength of an armored structure according to a representative embodiment, in terms of 3^{rd} principal stress (y axis on the left), plotted with squares, and Δf^{micro} (y axis on the right), plotted with circles, as a function of the sidewall angle.

As will be evident, the 3^{rd} principal stress (#) reduces significantly, and thus stability of the microstructures improves vastly, as a increases. On the other hand, liquid-solid contact fraction of the microstructures,

f_{orig}^{micro},will increase tof_{half}^{micro}

when half of the height is abraded. The increase of

Δf^{micro}=f_{half}^{micro}−f_{orig}^{micro} with α

means the liquid-solid contact area increases, i.e., the liquid adhesion force increases.

As will be apparent from the illustration, when the sidewalls 4 of the inverted pyramids defining the cavities form an angle α of 105°<α<135°, for example 120° to 125°, in particular 120°±2.5°, against the surface, sufficient properties of hydrophobicity and mechanical durability can be reached—both superhydrophobicity and mechanical stability can be balanced and guaranteed.

In particular, in one embodiment, at a value of α˜120° both superhydrophobicity and mechanical stability were achieved just as is low f^{micro}.

As discussed above, the armor exhibits dimensions in the micrometer range. In one embodiment, the cavities have a width (l) parallel to plane of 5 μm to 1 mm, and a height (or “depth”) (h), perpendicular to the width, of 1 μm to 1 mm.

In one embodiment, the cavities have a height (or “depth”) of 2 μm to 0.707 times the width.

In one embodiment, armor surfaces are constructed with a framework of microscale inverted pyramidal cavities. Using parameters including the width of the ridge w, i.e., the distance between the adjacent holes, width of the cavity 1, and the height h (FIG. 4), the liquid-solid contact fraction (f^{micro}) can be tailored according to equation (II).

$${f}^{micro} = \frac{2 w l + {w}^{2}}{{( w + l )}^{2}} \qquad ( II )$$

wherein

f^{micro} stands for liquid-solid contact fraction

w stands for the distance between two adjacent cavities and

l stands for width of a cavity.

Equation (II) for liquid-solid contact fraction is specific for square-shaped pyramids.

In one embodiment, the frame has a liquid-solid contact fraction f is 1.5 to 16%, for example less than 8%, such as 5.2 to 7.8%, the fraction being calculated from equation II above.

In one embodiment, the cavities are shaped as inverted pyramids having a polygon base (i.e. the opening of the cavities is defined by such a polygon). Thus, in one embodiment, each inverted pyramid has a triangular base, a square base, a hexagonal base or an octagonal base, in one embodiment, each inverted pyramid has independently such a polygon base, i.e. the pyramid bases can comprise combinations of two or more of triangular bases, square bases, hexagonal bases and octagonal bases.

In one embodiment, the inverted pyramids have an irregularly shaped polygon base. Such an “irregular” polygon base exhibits sides which have different lengths. Typically, each inverted pyramid has polygon bases with 3 to 13 corners, for example 4, 5, 6, 7, 8, 9, 10 or 11 corners (and sides).

In one embodiment, there are cavities being shaped by pyramids having at least 2, for example 3 to 10, different polygon bases.

In one embodiment, the frame of the substrate comprises, consists of or consists essentially of, a material selected from the group of silicon, ceramics, metal, polymer and glass and combinations thereof.

In one embodiment, the material is non-porous.

In another embodiment, the material is porous. In such an embodiment, the top surface forms the inverted pyramid structure, and the tip of the pyramid preferably will be open (or empty), so that air or gas can flow through.

In one embodiment, the material is silicon or silicate or aluminosilicate, or a transparent glass material.

In one embodiment, the material comprises a metal selected from the group of iron, nickel, copper, zinc and aluminium and alloys thereof, as well as combinations of one or several metals or metal alloys.

In one embodiment, the material comprises an aluminium alloy. Such an alloy can be anodically oxidized for example in order to further enhance the hardness and abrasion resistance performance.

In one embodiment, the substrate comprises a layer of Al₂O₃ on top of a layer of an aluminium alloy.

In one specific embodiment, inverted pyramidal microstructures with α˜125° are fabricated on silicon substrates by photolithography and chemical wet etching as the angle between Si (100) and Si (111) crystal planes is approximately 55°.

To achieve superhydrophobic properties, the armor frames are combined with hydrophobic structures selected from hydrophobic nanostructures. In one embodiment, the hydrophobic structures fill the cavities up to essentially the level of the bases of the inverted pyramids.

In one embodiment, the hydrophobic structures are bonded to the inside of the walls defining the cavities by physical or chemical bonds or by both physical and chemical bonds.

In one embodiment, the hydrophobic structures comprise particulate matter, in particular a material in the form of particles having an average particle size of 1000 nm or less, for example 250 nm or less, such as 10 to 150 nm. In one embodiment, the hydrophobic structures comprise fibrous matter, particularly a material in the form of fibers having an average particle size of 100 nm or less, for example 1 to 50 nm. In one embodiment, the hydrophobic structures comprise random roughness of on the cavity-facing sides of the sidewalls, said roughness being obtained for example by etching, in particular chemical etching. The random roughness typically gives rise to patterns of grooves and ridges with a width in the range of 1 to 100 nm.

In one embodiment, the hydrophobic nanostructures are selected from the group of soot-templated silica, superhydrophobic nano ZnO, and silica nanoparticles having a hydrophobic coating.

In one further embodiment, the surface is coated with an anti-abrasion layer, in particular an anti-abrasion layer of a material selected from the group of diamond-like carbon, diamond-like carbon/polydimethylsiloxane (PDMS), carbides, such as silicon carbide, metal oxides, such as aluminium oxide, and combinations thereof.

The nanostructures, such as nanoparticles or nanofibers, may have reactive surface groups capable of achieving or improving adhesion to the walls of the cavities. Examples of such groups include groups containing heteroatoms, such as oxygen or nitrogen, or unsaturation. Examples of groups include hydroxyl, oxo, imino, amino, vinyl, allyl, epoxy and acryl groups and combinations thereof.

### EXAMPLES

In one embodiment, fractal nanoclusters of silica were used as a model nanomaterial, as illustrated in FIG. 6. After fluorination, the composite surfaces exhibited excellent water repellency with static contact angle of 168±1°, and roll-off angle less than 1°. After repeated scraping by a steel blade, the armor microstructure shows excellent resistance to the vertical pressure and shear force, and the fractal nanostructure in between the armor keeps itself intact, as shown in FIG. 7.

It is notable that the abrasion removes the fluorinated silane layer from the top of armor microstructures altering local wetting from hydrophobic (θ_{Y}=115±1°) to hydrophilic (θ_{Y}=45±0.5°).

Using laser scanning confocal microscopy, it could be confirmed that the air-water-solid composite interface at microscale was very stable, since the air-liquid-solid three-phase contact line is supported by nanoscale superhydrophobic materials.

FIGS. 8A and 8B show the apparent contact angle and roll-off angle as function of liquid-solid contact fraction.

The larger the frame dimension (opening of cavities), the smaller the contact fraction, the higher will be the apparent contact angle and the lower will be the roll-off angle. As will appear, the impact of abrasion on apparent contact angle and roll-off angle (change from the upper curve to the lower curve in FIG. 8A; change from the filled symbols to the open symbols in FIG. 8B) will be smallest for low liquid-solid contact fraction (thus for large openings of the cavities—typically openings having a greatest dimension in the range of 100 to 1000 for example about 250 to 750 μm).

To demonstrate that the interconnected frame architecture, i.e., individual cavities designed with a large sidewall angle, is a generic concept to achieve the superior performances, inverted triangular pyramidal (tri-pyramidal) and inverted hexagonal pyramidal (hex-pyramidal) structures on silicon, metal and ceramic substrates were also fabricated (cf. FIG. 9A and FIG. 9B, respectively).

The Finite Element (FE) modeling demonstrated that the stress distribution on these interconnected frame architectures is relatively uniform, showing comparable mechanical robustness with the inverted pyramidal armor structure.

As shown in FIGS. 10A and 10B, after repeated scraping by a steel blade, the inverted tri-pyramidal and hex-pyramidal interconnected architectures ensure robust superhydrophobic property.

Long-term mechanical durability of armored superhydrophobic surfaces with different microstructures was also examined. The abrasion was conducted by using a polypropylene (PP) probe as the indenter with a defined vertical pressure (of 12 MPa) and reciprocating linear abrasion.

FIGS. 11A and 11B show the influence of linear abrasion cycles under the same load on apparent contact angle θ* (FIG. 11A) and roll-off angle θ_{roll-off} (FIG. 11B) for various superhydrophobic coatings. The key is the same for both panels, and data are mean±s. d. from at least five independent measurements.

As shown in FIGS. 11A and 11B, the armored superhydrophobic surfaces (labelled “inverted tri-pyramid”, “inverted pyramid” and “inverted hex-pyramid”, respectively) maintained the static contact angle above 150° and roll-off angle less than 12° even after 1000 abrasion cycles, and present an ideal resistance to the shear force and protection for the silica nanomaterials inside.

To further illustrate the mechanical durability of the present armored superhydrophobic surfaces, FIG. 12 gives a comparison of the mechanical stability among different superhydrophobic surfaces; the same color area indicates the superhydrophobic surfaces with mechanical stability on the same order of magnitude, and the error bars indicate standard deviations from at least five independent measurements.

Specifically, the maximum number of abrasion cycles is measured to be more than 1000, which is about 10 times higher than for conventional superhydrophobic surfaces.

Further tests were carried out as follows:

### Tape-Peeling Test

The tape-peeling tests were conducted to evaluate the adhesion stability of the filling nanomaterials. The 3M™ VHB™ 5925 tape (with adhesion to steel value of 3000 N m¹) was used for the tape-peeling test. The tape has a thickness of 0.6 mm and width of 20 mm. The pressure was applied by using a cylindrical copper block (4.5 kg) as a roller. The superhydrophobicity of the armored surface was maintained (θ* ca 154° and θ_{roll-off} ca 8°) after 100 cycles, which is 10 times higher than the pure soot-templated nanosilica surfaces.

### Taber Abrasion Test

The ASTM standard tests were performed following D4060 standard, using a Taber abrasion tester. The Taber machine uses two loaded abrasive wheels (CALIBRASE® CS-10, from TABER® INDUSTRIES) against which the superhydrophobic samples are rubbed using a rotary platform. The abrasion test was conducted on the armored superhydrophobic ceramic substrate with a size of 10.5 cm * 10.5 cm. According to the ASTM D4060 standard, the substrate running one rotation was counted as one cycle. The armored ceramic surface can maintain superhydrophobicity after 240 cycles (θ* remained above 155° and θ_{roll-off} below 10°), i.e. about 10 times more than the commercial Ultra-Ever Dry coating surfaces.

### Sharp Object Scratch Test

Sharp object scratch tests were performed using a stainless-steel needle as the indenter. In the test setup a stainless-steel needle with a tip size of 5 μm, which is much smaller than the armor cavities size (25 μm). After the needle scratching along the surface with 15 mm distance under 1 N load (ca 50 GPa), the tip was bent seriously during the abrasion on armor structures. The ultra-sharp tip damages the first contacted cavity and filling nanomaterials. When the tip slides further over the surface, the small contact area between the tip and cavity wall induces an extremely high pressure under shear motion, enforcing the tip to bend. As a consequence, the bended object with increased tip size could not penetrate the next cavities anymore.

Further, a metal brush abrasion test was carried out using a stainless steel needle with the diameter of 350 μm). The armored surface can still keep its superhydrophobicity after metal brush scratch.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, to give a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

### REFERENCE NUMERALS

1 Frame
2 Hydrophobic material
3 Cavities
4 Sidewalls
5 Superhydrophobic material
6 Hydrophilic site

### INDUSTRIAL APPLICABILITY

The present superhydrophobic substrates are generally useful as surfaces in materials and constructions where surfaces having properties of self-cleaning, anti-fouling and staying dry are desired. Such applications can be found in the fields of biotechnology and medicine. Further, the materials are useful in heat transfer applications. Since the frame can be manufactured from transparent or translucent materials, the present superhydrophobic materials are also useful in applications where transparent surfaces are needed. One important application includes the use of the present surfaces in solar cells.

1. A substrate having a superhydrophobic surface, comprising:
a frame of a first material of interconnected structures exhibiting cavities having the shape of inverted pyramids; and
a second material comprising hydrophobic structures filling the cavities,
wherein the sidewalls of the inverted pyramids form an angle α of 105°<α<135° against said surface.

2. The substrate according to claim 1, wherein the cavities are defined by sidewalls of the inverted pyramids forming an angle α of 110° to 130°, for example 115° to 125°, in particular 120°±2.5° against said surface.

3. The substrate according to claim 1, wherein the cavities have a width (1) parallel to plane of 5 μm to 1 mm, and a height (h), perpendicular to the width, of 1 μm to 1 mm.

4. The substrate according to claim 1, wherein the cavities have a height of 2 μm to 0.707 times the width.

5. The substrate according to claim 1, having a liquid-solid contact fraction f of less than 8%, the relation between the liquid-solid contact fraction f, the Young's contact angle θ_{Y} and the apparent contact angle θ* being calculated using the Cassie-Baxter model (equation I):
cos θ*=f(1+COS θ_{Y})−1 (I)

6. The substrate according to claim 1, wherein the cavities exhibit a square shaped base and the substrate exhibits a liquid-solid contact fraction f of less than 8%, said fraction being calculated from the equation II
$${f}^{micro} = \frac{2 w l + {w}^{2}}{{( w + l )}^{2}} \qquad ( II )$$
wherein
f^{micro} stands for liquid-solid contact fraction,
w stands for the distance between two adjacent cavities, and
l stands for width of a cavity.

7. The substrate according to claim 6, wherein the liquid-solid contact fractionf is 1.5 to 8%, for example 5.2 to 7.8%.

8. The substrate according to claim 1, wherein the cavities have the shape of inverted pyramids having a polygon base.

9. The substrate according to claim 1, wherein each inverted pyramid has independently a triangular base, a square base, a hexagonal base or an octagonal base, preferably each inverted pyramid has a triangular base, a square base, a hexagonal base or an octagonal base.

10. The substrate according to claim 1, wherein each of the inverted pyramids has an irregular polygon base comprising 4, 5, 6, 7, 8, 9, 10 or 11 sides.

11. The substrate according to claim 1, wherein the frame of the substrate comprises a material selected from the group of silicon, ceramics, metals and alloys thereof, glass, as well as combinations of two or more of said materials, in particular the material is silicon, metal, metal alloy, or a transparent glass material.

12. The substrate according to claim 1, wherein the hydrophobic structures are hydrophobic nanostructures.

13. The substrate according to claim 1, wherein the hydrophobic structures fill the cavities up to essentially the level corresponding to the bases of the inverted pyramids.

14. The substrate according to claim 1, wherein the hydrophobic structures are bonded to the inside of the walls defining the cavities by physical or chemical bonds or by both physical and chemical bonds.

15. The substrate according to claim 1, wherein hydrophobic structures comprise particulate matter, in particular a material in the form of particles having an average particle size of 1000 nm or less, for example 250 nm or less.

16. The substrate according to claim 1, wherein hydrophobic structures comprise fibrous matter, particularly a material in the form of fibers having a fiber diameter of 100 nm or less.

17. The substrate according to claim 1, wherein hydrophobic structures comprise random roughness on the cavity-facing sides of the sidewalls, said roughness being obtained for example by etching, in particular chemical etching.

18. The substrate according to claim 1, wherein the hydrophobic nanostructures are selected from the group of soot-templated silica, superhydrophobic nano ZnO, and silica nanoparticles having a hydrophobic coating.

19. The substrate according to claim 1, wherein the surface is coated with an anti-abrasion layer, in particular an anti-abrasion layer of a material selected from the group of diamond-like carbon, diamond-like carbon/polydimethylsiloxane (PDMS), carbides, such as silicon carbide, metal oxides, such as aluminium oxide, and combinations thereof.

20. The substrate according to claim 1, wherein the surface is generally planar or curved, preferably planar.

21. The substrate according to claim 1, wherein the frame is formed by a plurality of adjacent, truncated, inverted pyramids which are interconnected at their sidewalls at the base of the pyramids.

22. The substrate according to claim 1, wherein the substrate exhibits properties selected from the group of robustness, durability and abrasion resistance and combinations thereof.

23. The substrate according to claim 1, wherein the substrate is capable of exhibiting superhydrophobicity after 100 cycles of a Taber abrasion test performed following the ASTM D4060 standard, using a Taber abrasion tester on a substrate with a size of 10.5 cm * 10.5 cm.

24. The substrate according to claim 1, wherein the substrate is capable of exhibiting superhydrophobicity even after 500 cycles, in particular even after 1000 cycles, of linear abrasion using an abradant at a preselected pressure, such as a polypropylene abradant at a pressure of 12 MPa.

25. The substrate according to claim 1, wherein the substrate is capable of exhibiting superhydrophobicity even after 100 cycles of a tape-peeling test carried out using a tape having an adhesion to steel of 3000 N m¹ and applied against the surface using a 4.5 kg weight, such as a cylindrical weight, for example as a roller.

26. The substrate according to claim 23, wherein the substrate exhibits an apparent contact angle θ* of ca 154° and θ_{roll-off} of ca 8°.

27. A method of producing a substrate having a superhydrophobic surface, comprising:
providing a frame of a first material of interconnected structures exhibiting cavities having the shape of inverted pyramids, wherein the sidewalls of the inverted pyramids form an angle α of 105°<α<135° against said surface; and
providing a second material comprising hydrophobic structures to fill the cavities.

28. The method according to claim 27, further comprising the steps of:
providing a substrate having a surface; and
forming in the surface a frame of interconnected structures of cavities having the shape of inverted pyramids.

29. The method according to claim 27, further comprising forming the cavities by embossing, roll-to-plate imprinting, roll-to-roll imprinting, laser patterning, laser ablation, and additive manufacturing (also called 3D printing) of or on the substrate.

30. The method according to claim 29, further comprising using a mold having protrusions in the form of pyramids for forming pattern of inverted pyramids in a surface of the substrate.

31. The method according to claim 27, wherein the substrate comprises silicon, ceramics, metals and alloys thereof, glass, and combinations of two or more of said materials, in particular the material is silicon, metal, metal alloy, or a transparent glass material.

32. The method according to claim 27, wherein the hydrophobic structures are hydrophobic nanostructures.

33. The method according to claim 27, wherein the hydrophobic structures are bonded to the cavity-facing surfaces of the sidewalls of the inverted pyramids by physical or chemical bonds or by both physical and chemical bonds.

34. The method according to claim 33, wherein substrate is subjected to a treatment in order to increase bonding of the hydrophobic structures to the cavities, such treatment for example being carried out by plasma etching, by chemical etching or by using a primer or a combination thereof.

35. The method according to claim 27, wherein hydrophobic structures comprise particulate matter, in particular a material in the form of particles having an average particle size of 1000 nm or less, preferably 250 nm or less.

36. The method according to claim 27, wherein hydrophobic structures comprise fibrous matter, particular a material in the form of fibers having an average particle size of 1000 nm or less, in particular 250 nm or less.

37. The method according to claim 27, wherein hydrophobic nanostructures comprise random roughness of the cavity-facing surface of the walls of the cavities, said roughness being obtained for example by etching, in particular chemical etching.

38. The method according to claim 27, wherein the cavities of frame are filled with hydrophobic nanostructures selected from the group of soot-templated silica, superhydrophobic nano ZnO, and silica nanoparticles having a hydrophobic coating, said particles at least partially bonding to the cavity-facing surfaces of the walls of the cavities by physical or chemical bonds or a combination thereof.

39. The method according to claim 27, further comprising coating the surface formed by an anti-abrasion layer, in particular an anti-abrasion layer of a material selected from diamond-like carbon, diamond-like carbon/PDMS, carbides, such as silicon carbide, metal oxides, such as aluminium oxide, and combinations thereof.

40. The use of a substrate according to claim 1 as a surface in self-cleaning, anti-fouling or heat transfer materials.

41. The use of a substrate according to claim 1 in transparent surfaces, in particular in solar cells.
